(19) United States
(12) Patent Application Publication
(10) Pub. No.: US 2015/0141157 A1
(43) Pub. Date: May 21, 2015

(54) Video game steering wheel mount

(71) Applicant: Michael James Sullivan, Dublin, OH (US)

(72) Inventor: Michael James Sullivan, Dublin, OH (US)

(21) Appl. No.: 14/084,640

(22) Filed: Nov. 20, 2013

(51) Int. Cl. A63F 13/245; A63F 13/98

(52) U.S. Cl. CPC A63F 13/245; A63F 13/98
USPC 463/47

(57) ABSTRACT

The present invention relates to a video game steering wheel mount for mounting video games steering wheels. The invention comprise of a base where the user sits, a mounting plate to mount the video game steering wheel, an extension post connecting the base as well as the mounting plate. Weight of the user is utilized to stabilize the device. The invention bears adjustable angles which can be flexibly adjusted as per the user's preference.

### CROSS-REFERENCE TO RELATED APPLICATIONS

This application claims the benefit of U.S. provisional application No. 61/728,514 filed on Nov. 20, 2012.

### BACKGROUND OF INVENTION

1. Field of Invention

The present invention relates to a video game steering wheel mount designed to be used with racing related video games.

2. Description of Prior Art

Video game consoles such as PlayStation 3 and Xbox 360 are connected to suitable large television screens to give enhanced, more real and involved user experience. The higher end video game steering wheels made by companies like Logitech have highlighting features that include internal motors to simulate driving dynamics such as wheel resistance, vibrations, skidding, traction etc. Driving with these parameters require a stable mounting surface to mount the video game steering wheels.

Various competitive products in the market provide solutions for mounting these gaming steering wheels but fails on account of being heavier, large, not very portable and expensive. The present market consist of products that sit in front of the user like a ‘tray table’, or simulate a driver's cockpit where the user actually sits in, just similar to the driver's cockpit in a car. Other such devices sit on the user's lap and possess flaps that wrap around the user's legs. The closest prior art is one such device earlier manufactured by Logitech and approximately of the same size and dimensions as the present invention, wherein the user has to squeeze the device with their thighs in order to stabilize the overall device. Whereas the present invention offers stable ergonomics and enhanced stability of the device.

Although, there are a plenty of familiar designs and configurations available in the prior art but we will mention the most relevant prior art in context of our invention. U.S. Pat. No. 8,197,341 to Gray (2012) relates to a supporter for video game controller with a base adapted to support on the floor, a platform for mounting hand operated device of the video game controller and another platform for mounting the foot operated device of the video game. Another U.S. Pat. No. 7,828,157 to Thorsen (2010) talks about a steering wheel stand for electronic game control including a hollow tubing resting on the pair of base legs. Yet another U.S. Pat. No. 7,753,787 to Arche et al. (2010) relates to a convertible lap rest and table mount for racing wheel.

While the aforementioned patents fulfill their intended purpose but the present invention is a substantial improvement over the existing prior art due to the improved features and physical ergonomics which appreciably reduce the weight and size of the entire unit and enhances overall stability. The user's weight ultimately holds the invention stable with little or no effort on part of the user to externally stabilize the device unlike prior arts.

### SUMMARY OF THE INVENTION

The present invention comprises a base or a seat on which the user sits. The weight of the user itself is utilized to keep the video game steering wheel mount stable. The present invention also embodies a mounting plate on which the video game steering wheel is mounted and an extension post which is connected to the base at one end and to the mounting plate at other end. The mounting plate to which the video game steering wheel is fastened, typically bear clamps to hold the steering wheel firmly onto the mounting plate. The present invention also embodies a clamping mechanism which may be used to easily clamp the invention onto a standard desk in front of the video game monitor.

According to one aspect of the present invention, the angle between base and extension post is adjustable depending upon the user's driving preference.

According to yet another aspect of present invention, the angle between extension post and mounting plate is adjustable depending upon the user's driving preference.

According to another aspect of the present invention, the base, extension post and mounting plate are fastened together to form a single unit. Fastening methods may include welding, fastening with bolts, screws, rivets and injection molding.

According to yet another aspect of the present invention, base and mounting plate can be accessorized with attachments like joysticks and pedals. These attachments may be fastened to the base and mounting plate by welding, bolts, screws, rivets and other alternative methods.

The present invention may be styled, shaped and designed by utilizing various methods like thermoforming, injection molding and pressure forming. The present invention may come as a consolidated single unit or segmented three piece design format. Consequently, the three segments i.e. base, extension post and mounting plate can be conveniently fastened by screws, bolts and rivets at the user end.

According to yet another aspect of the present invention, the mounting plate is designed to accommodate most steering wheel fastening mechanisms and can be augmented with specific adapter plates that can be attached to the mounting plate to provide a more secured and customized fit to the individual steering wheel models.

For a better understanding of the present invention, the matter disclosed henceforth will describe the invention and its preferred embodiments in the best possible manner.

### BRIEF DESCRIPTION OF THE DRAWINGS

The embodiments of the present invention can be better understood with the help of accompanying drawings wherein;

FIG. 1 shows a side view of the video game steering wheel mount with clamping mechanism.

FIG. 2 shows a perspective view of the video game steering wheel mount being compared to a chair.

FIG. 3 shows a perspective view of a fabricated video game steering wheel mount.

FIG. 4 shows a side view of the video game steering wheel mount.

FIG. 5 shows a front view of the video game steering wheel mount with foot pedals at the base.

### DETAILED DESCRIPTION OF THE PREFERRED EMBODIMENTS

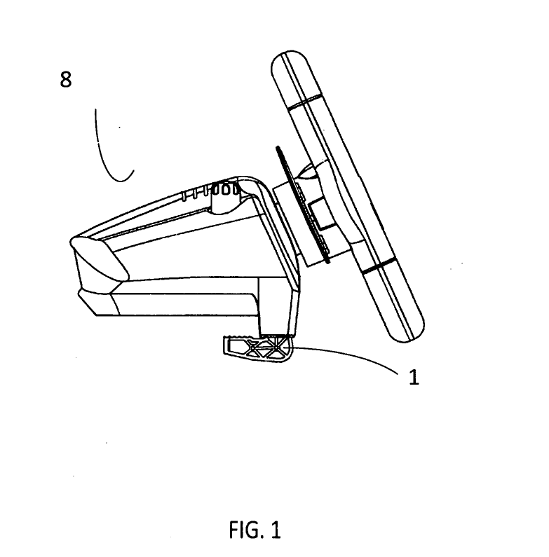

FIG. 1 represents a side view of the video game steering wheel mount 8 showing a clamping mechanism 1 that can clamp onto a standard desk in front of the video game monitor where the user is seated.

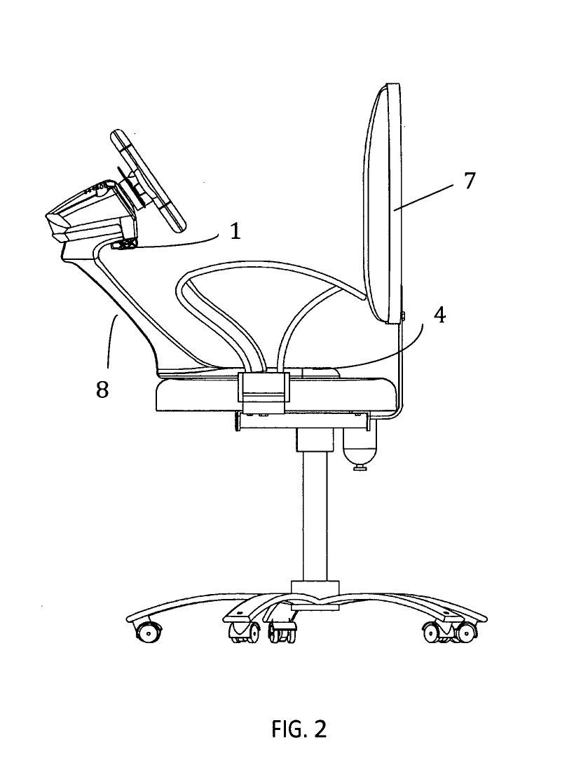

FIG. 2 represents a perspective view of the video game steering wheel mount 8 being compared to a chair 7 in such a way that a user can sit on base 4 of the device 8, similar to sitting on a chair. Base 4 symbolizing the seat of chair 7.

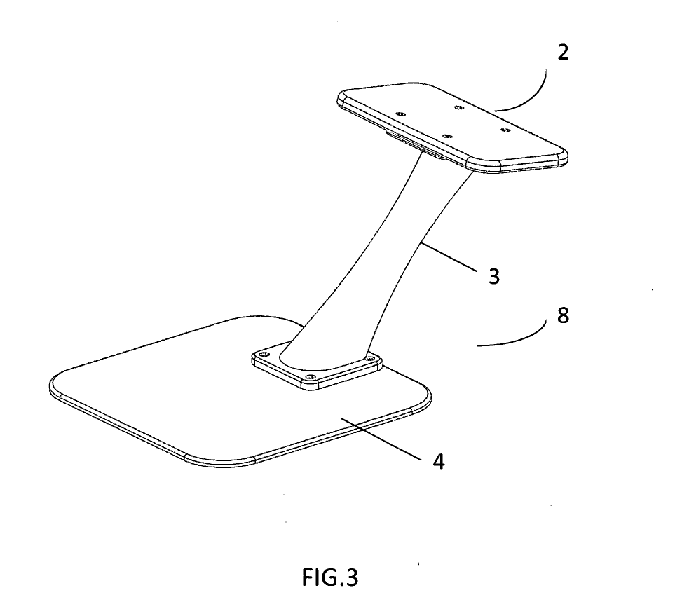

FIG. 3 represents a perspective view of a fabricated video game steering wheel mount 8 with a base 4, an extension post 3 attached to base 4 and a mounting plate 2 for mounting the video game steering wheel. The steering wheel mount 8 can be fabricated with wood, plastic or metal depending on the manufacturing and user requirements.

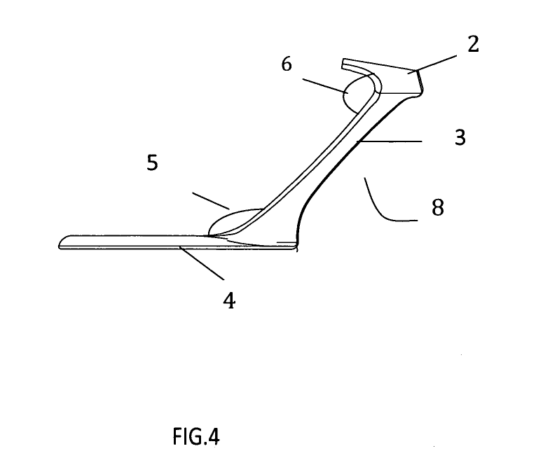

FIG. 4 represents a side view of video game steering wheel mount 8. Base 4 is connected to an extension post 3. Extension post 3 is further connected to a mounting plate 2. User sits on base 4 in order to play. Weight of the user on base 4 is utilized in keeping device 8 stable. The video game steering wheel is mounted on the mounting plate 2. Angle 6 between extension post 3 and mounting plate 2 is adjustable as per user preference. Additionally, angle 5 between base 4 and extension post 3 is adjustable as per the preference of the user.

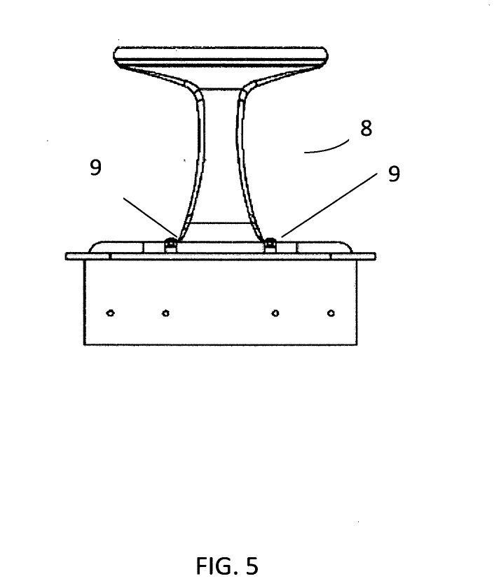

FIG. 5 represents a front view of video game steering wheel mount 8 with attached accessory food pedals 9 at base 4. Foot pedal 9 enhances the real time driving experience of the concerned user while using the video game steering wheel which is mounted on mounting plate 2.

While the written description of the invention describes the invention in the best possible manner thereof, it is expected that the ordinary skilled in the art understand the variations, modifications and combinations of the preferred embodiments. Therefore, the invention shall not be construed as limiting by the mentioned embodiments, methods, terminologies or phraseologies, but by all embodiments and methods within the scope and ambit of the invention claimed.

What is claimed is:

1. A video game steering wheel mount , comprising:
a mounting plate on which the steering wheel is mounted or fastened;
an extension post connecting the base to the mounting plate;
an ergonomic base supporting the extension post;
a clamping mechanism to clamp the invention to a desk.

2. A video game steering wheel mount according to claim 1, wherein the user sits on the base, thus causing the overall weight of the player to hold the device's platform stable with little or no effort on part of the player to externally stabilize the device.

3. A video game steering wheel mount according to claim 1, wherein a variety of fastening methods are used to fasten mounting plate , extension post and base.

4. A video game steering wheel mount according to claim 3, wherein the mounting plate, extension post and base are fastened together through welding or reversible means like screws, rivets or manufactured as a single consolidated unit through a process such as injection molding.

5. A video game steering wheel mount according to claim 1, wherein the device itself comes as a consolidated single unit or segmented three piece design format. The three segments i.e. base, extension post and mounting plate can be conveniently fastened with screws, rivets and bolts at the user end.

6. A video game steering wheel mount according to claim 1, wherein the angle between extension post and mounting plate is adjustable, depending upon the driving preference of the player.

7. A video game steering wheel mount according to claim 1, wherein the angle between base and extension post is adjustable, depending upon the driving preference of the player.

8. A video game steering wheel mount according to claim 1, wherein the mounting plate, extension post and base could be made up of a variety materials, styles and dimensions.

9. A video game steering wheel mount according to claim 1, wherein a provision is made for accessories attachment at the base and on the mounting plate.

10. A video game steering wheel mount according to claim 9, wherein the accessories include foot pedals attached at the base along with joystick and desktop attachments clamped with the mounting plate.

11. A video game steering wheel mount according to claim 9, wherein a variety of clamping mechanisms including screws, bolts and rivets are employed to fasten accessories at the base and on the mounting plate.

12. A video game steering wheel mount according to claim 1, wherein the mounting plate is designed to accommodate most steering wheel clamping mechanisms. The mounting plate can be augmented with specific adapter plates that can be attached to the mounting plate to provide a more secured and customized fit for the individual steering wheel models.

13. A video game steering wheel mount according to claim 1, wherein the base, mounting plate and extension post are shaped and designed employing thermoforming, injection molding and pressure forming methods.

14. A video game steering wheel mount according to claim 1, wherein the device can be fabricated with a variety of materials including wood, plastic and metal.
